(19) United States
(12) Patent Application Publication
(10) Pub. No.: US 2026/0342199 A1
(43) Pub. Date: Oct. 29, 2026

(54) MOTOR GENERATOR

(71) Applicant: Shu-Shoung KUO, Taipei City (TW)

(72) Inventor: Shu-Shoung KUO, Taipei City (TW)

(21) Appl. No.: 18/995,805

(22) PCT Filed: Mar. 20, 2023
(86) PCT No.: PCT/CN2023/082482

§ 371 Date: Jan. 16, 2025

(30) Foreign Application Priority Data
Aug. 8, 2022 (CN) 202210943762.X

(51) Int. Cl. H02K 53/00; H02K 19/26; H02N 15/00

(52) U.S. Cl. CPC H02K 53/00; H02K 19/26; H02N 15/00

(57) ABSTRACT

The motor generator includes an enclosure body, a vacuum enclosed space, a magnetic levitation rotating member, first magnetic levitation elements, first rotational magnetic elements, second magnetic levitation elements, and second rotational magnetic elements. The magnetic levitation rotating member, functioning like a magnetic levitation turntable, is driven to rotate by a structure resembling a linear motor. The magnetic levitation rotating member is connected to a power-generating rotating member, which is driven to rotate as well. Multiple power-generating magnetic elements are arranged on the power-generating rotating member, while the enclosure body is equipped with multiple power-generating coils positioned on one side of the power-generating magnetic elements, forming a power generation structure. A power supply device, controlled via a status control element, supplies current to the second magnetic levitation elements and the second rotational magnetic elements to regulate the state of the magnetic levitation rotating member.

### BACKGROUND OF THE INVENTION

### (a) Technical Field of the Invention

The present invention generally relates to a motor generator, and more particularly to an eco-friendly motor generator that is not limited by environmental conditions.

### (b) Description of the Prior Art

Before the Industrial Revolution, Earth was a clean and unpolluted place. However, with industrial development, pollution and excessive exploitation of energy resources began. The widespread use of transportation further worsened air quality and increased emissions from industrial production. Today's technology-driven world heavily relies on electricity, creating a growing demand for energy. This, in turn, leads to more emissions from burning fossil fuels. Although nuclear power generation produces no direct emissions, its used fuel rods still pollute the Earth, and accidents at nuclear power plants cause even more severe pollution. Nuclear disasters in Japan and Russia have left permanent damage to the planet.

Regardless of the power generation method, most require large facilities that cannot be easily located in residential areas. Their maintenance and repairs are also complex and challenging. Additionally, all power plants need long-distance electricity transmission. To reduce transmission losses, electricity is transformed into high-voltage power of thousands of volts. However, this high-voltage transmission generates low-frequency ionizing radiation, which can cause leukemia among nearby residents. This not only results in potential energy loss but also poses health risks to surrounding communities.

### SUMMARY OF THE INVENTION

To address the above shortcomings, the primary objective of the present invention is to provide an eco-friendly motor generator that is not limited by environmental conditions.

By utilizing the magnetic levitation effect and a driving mechanism similar to a linear motor, the generator performs low-loss power generation. Combined with electromagnetic effects, it efficiently produces electrical energy. This approach achieves an amplifier-like effect, generating high-power output from low-power input through a low-loss process.

The motor generator includes
an enclosure body;
an enclosed space formed within the enclosure body, where the enclosed space is in a vacuum state;
a magnetic levitation rotating member rotatably configured within the enclosed space;
multiple first magnetic levitation elements configured on the magnetic levitation rotating member;
multiple second magnetic levitation elements configured on the enclosure body positioned correspondingly to the first magnetic levitation elements, where the magnetic levitation rotating member is in a magnetic levitation state by the first and second magnetic levitation elements;
multiple first rotational magnetic elements configure on the magnetic levitation rotating member;
multiple second rotational magnetic elements configured on the enclosure body positioned correspondingly to the first rotational magnetic elements, where the magnetic levitation rotating member is driven to rotate by magnetic force between the first and second rotational magnetic elements;
a power-generating rotating member configured within the enclosed space and fixed to the magnetic levitation rotating member;
multiple power-generating magnetic elements configured on the power-generating rotating member;
multiple power-generating coils configured on the enclosure body adjacent to the power-generating magnetic elements, where current is induced in the power-generating coils by the power-generating magnetic elements;
an energy storage device electrically connected to the power-generating coils;
a power supply device electrically connected to the power-generating coils, the second magnetic levitation elements, and the second rotational magnetic elements, where current is received from the power-generating coils and supplied to the second magnetic levitation elements the second rotational magnetic elements; and
a status control element data-linked to the power supply device controlling current supplied to the second magnetic levitation elements and the second rotational magnetic elements.

The motor generator may further include a status monitoring device data-linked to the power supply device and the enclosure body.

The motor generator may further include a notification device data-linked to the status monitoring device and the status control element.

Specifically, the magnetic levitation rotating member and the power-generating rotating member spin in the enclosed space which is in a vacuum state.

Additionally, multiple rotational buffer elements are arranged along an inner wall of the enclosure body.

Additionally, multiple magnetic levitation buffer elements are arranged along an inner wall of the enclosure body.

Additionally, the magnetic levitation rotating member is equipped with a magnetic levitation center-of-gravity limiting element; and the power-generating rotating member is equipped with a rotor center-of-gravity limiting element.

Specifically, the first magnetic levitation elements and the second magnetic levitation elements achieve magnetic levitation to the magnetic levitation rotating member through electromagnetic levitation or superconducting magnetic levitation.

Specifically, the first magnetic levitation elements and the first rotational magnetic elements are permanent magnets.

Specifically, the second magnetic levitation elements and the second rotational magnetic elements are excitation coils.

With the above-described structure, the status control element can control the power supply device to provide electricity to the second magnetic levitation elements and second rotational magnetic elements. This regulates the magnetic state of these elements, allowing the repelling effect between the second magnetic levitation elements and the first magnetic levitation elements to keep the magnetic levitation rotating member in a levitated state. Additionally, by controlling the electromagnetic state of the second rotational magnetic elements, the magnetic levitation rotating member is driven to rotate through a mechanism similar to a linear motor in coordination with the first rotational magnetic elements.

As the magnetic levitation rotating member rotates, it drives the power-generating rotating member (i.e., the rotor) and the power-generating magnetic elements to rotate as well. This induces current in the power-generating coils (i.e., the stator) through the power-generating magnetic elements. The generated current is then transmitted to the energy storage device and the power supply device for consumption.

Since the magnetic levitation rotating member and the power-generating rotating member rotate within a vacuum-enclosed space, air resistance is minimized, significantly reducing energy loss during power generation. Furthermore, as the system generates electricity through electromagnetic effects, it produces no pollution or noise. Additionally, the design is not restricted by environmental constraints, greatly enhancing overall convenience.

The disclosed motor generator addresses the common issues in traditional power generation equipment, such as pollution and environmental limitations during operation, achieving the practical advancements described above.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a motor generator according to a first embodiment of the present invention.

FIG. 2 is a perspective break-down diagram showing the motor generator of FIG. 1.

FIG. 3 is a sectional diagram showing the motor generator of FIG. 1.

FIG. 4 is a sectional diagram showing the motor generator of FIG. 1.

FIG. 5 is a sectional diagram showing the motor generator of FIG. 1 operating with magnetic levitation

FIG. 6 is a top-view diagram showing the motor generator of FIG. 1 operating with magnetic levitation

FIG. 7 is a sectional diagram showing the motor generator of FIG. 1 generating electricity.

FIG. 8 is a functional block diagram showing the interaction between the components of the motor generator of FIG. 1.

FIG. 9 is a sectional diagram showing a motor generator according to a second embodiment of the present invention.

FIG. 10 is a functional block diagram showing the motor generator of FIG. 10.

FIG. 11 is a sectional diagram showing a motor generator according to a third embodiment of the present invention.

FIG. 12 is a sectional diagram showing a motor generator according to a fourth embodiment of the present invention.

FIG. 13 is a sectional diagram showing a motor generator according to a fifth embodiment of the present invention.

FIG. 14 is a sectional diagram showing a motor generator according to a sixth embodiment of the present invention.

FIG. 15 is a sectional diagram showing a motor generator according to a seventh embodiment of the present invention.

FIG. 16 is a perspective diagram showing a motor generator according to an eighth embodiment of the present invention.

FIG. 17 is a perspective diagram showing an operation scenario of the motor generator of FIG. 16.

FIG. 18 is a perspective diagram showing a motor generator according to a ninth embodiment of the present invention.

FIG. 19 is a sectional diagram showing a motor generator according to a tenth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

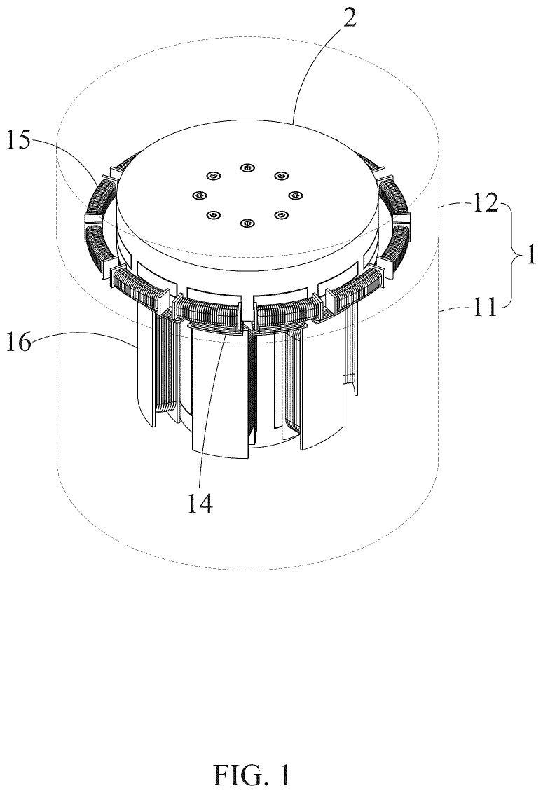

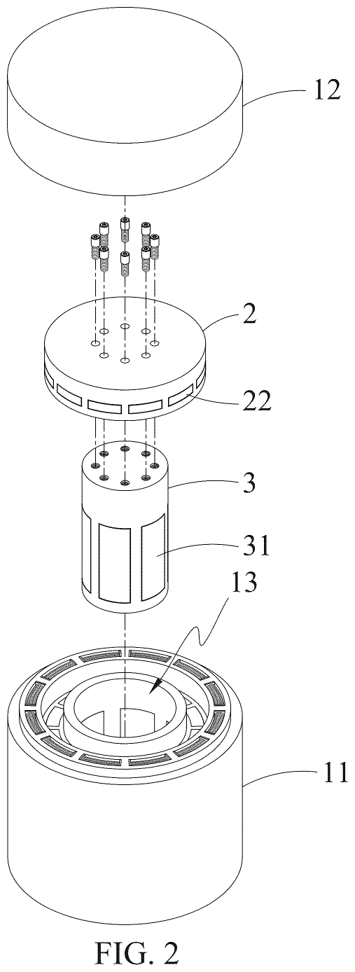

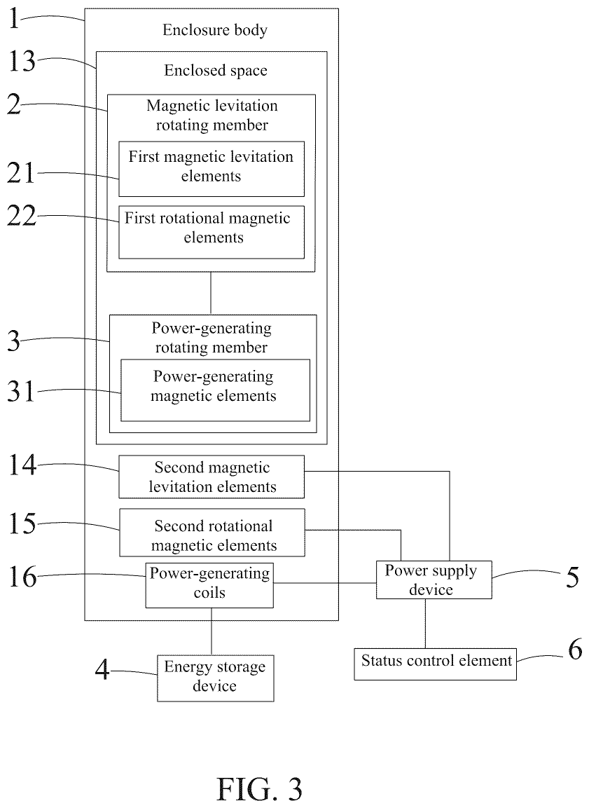

As shown in FIGS. 1 to 4, a motor generator according to a first embodiment of the present invention includes the following components.

An enclosure body 1 includes a supporting member 11 and a covering member 12 positioned on top of and joined to the supporting member 11.

An enclosed space 13 is formed within the enclosure body 1 by the supporting and covering members 11 and 12, and the enclosed space 13 is in a vacuum state. In this embodiment, the vacuum state is achieved by extracting the air from the enclosed space 13 using a high-pressure vacuum pump, as an example.

A magnetic levitation rotating member 2 is positioned within the enclosed space 13. In this embodiment, the magnetic levitation rotating member 2 is a circular turntable with a downward extended ring wall, achieving an inverted U-shaped cross-section as an example.

Multiple first magnetic levitation elements 21 are arranged along a bottom side of the ring wall surrounding magnetic levitation rotating member 2. In this embodiment, the first magnetic levitation elements 21 are exemplified as permanent magnets.

Multiple second magnetic levitation elements 14 are arranged on a top side of the supporting member 11, each positioned correspondingly to a first magnetic element 21. In this embodiment, the second magnetic levitation elements 14 are exemplified by excitation coils whose magnetic state can be controlled via a power supply.

Multiple first rotational magnetic elements 22 are arranged along an outer surface of the ring wall of the magnetic levitation rotating member 2. In this embodiment, the first rotational magnetic elements 22 are exemplified as permanent magnets.

Multiple second rotational magnetic elements 15 are arranged on a top side of the supporting member 11 of the enclosure body 1, each positioned correspondingly to a first rotational magnetic element 22. In this embodiment, the second rotational magnetic elements 15 are exemplified by excitation coils whose magnetic state can be controlled via a power supply.

A power-generating rotating member 3 is fixed to the magnetic levitation rotating member 2, serving as the rotor as in electric generators, is exemplified in this embodiment by a metal cylinder screwed to the lower side of the magnetic levitation rotating member 2.

Multiple power-generating magnetic elements 31 are arranged along a cylindrical outer surface of the power-generating rotating member 3. In this embodiment, the power-generating magnetic elements 31 are exemplified by permanent magnets.

Multiple power-generating coils 16 are arranged along an inner side wall of the supporting member 11 of the enclosure body 1, serving as the stator as in electric generators, adjacent to the power-generating magnetic elements 31.

An energy storage device 4 is electrically connected to the power-generating coils 16.

A power supply device 5 is electrically connected to the power-generating coils 16, the second magnetic levitation elements 14, and the second rotational magnetic elements 15. In this embodiment, both the energy storage device 4 and the power supply device 5 are exemplified by rechargeable batteries capable of storing and supplying power.

A status control element 6 is data-linked to the power supply device 5. In this embodiment, the status control element 6 is exemplified by an electronic controller.

As described above, the disclosed motor generator can be operated without environmental restrictions while offering the advantage of green energy efficiency.

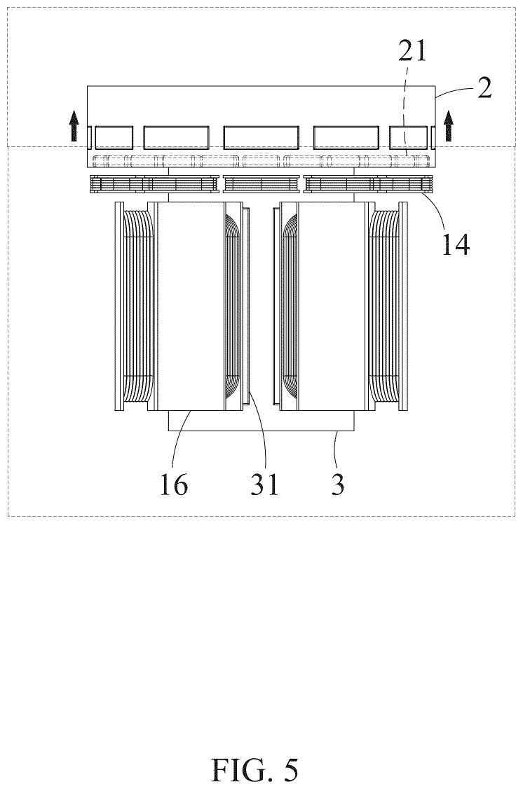

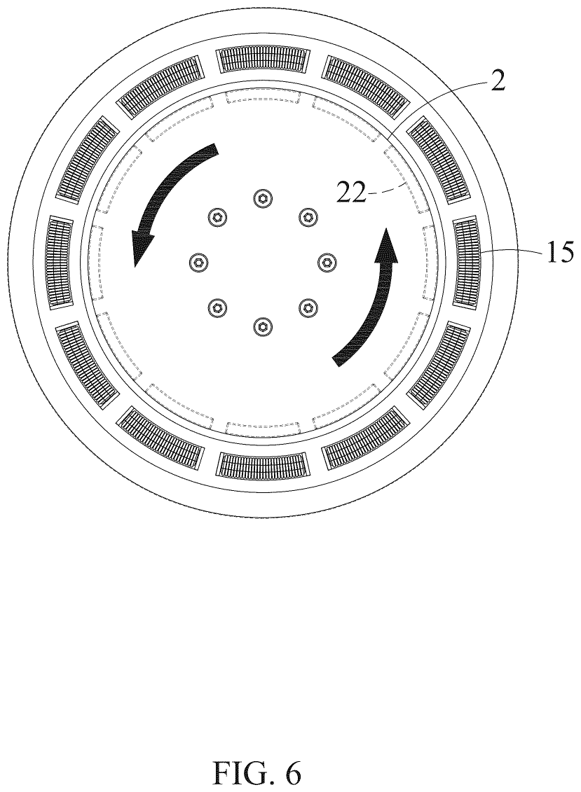

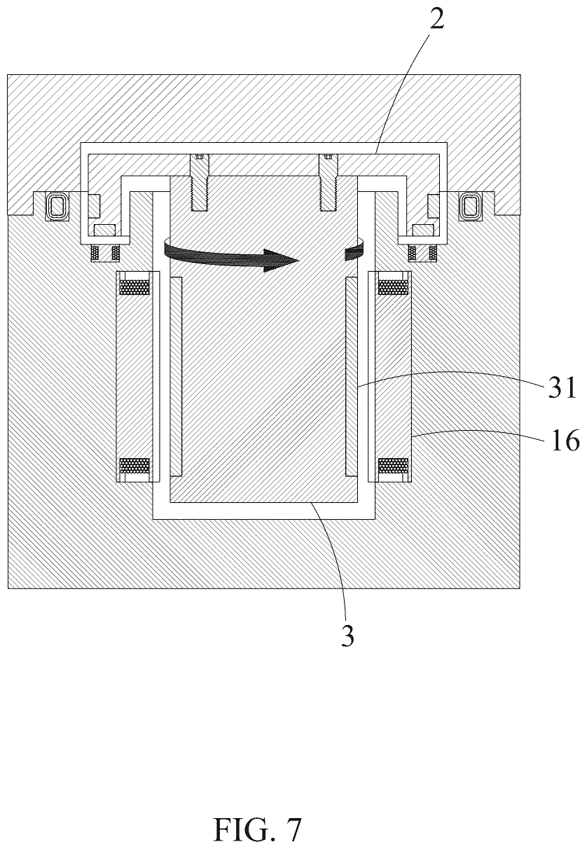

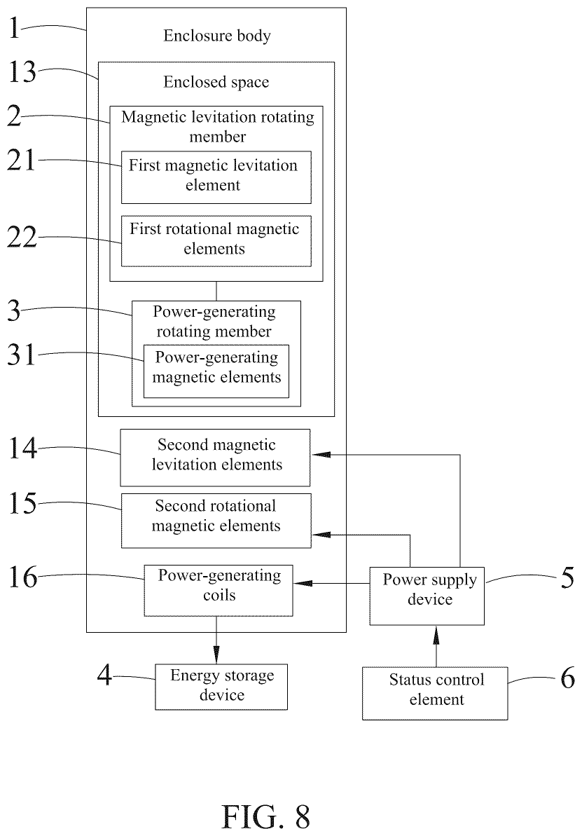

As shown in FIGS. 1 to 8, sufficient electrical energy is first stored in the power supply device 5 and the power-generating rotating member 3 (i.e., rotor) is secured to the lower side of the magnetic levitation rotating member 2 using screws. Next, the magnetic levitation rotating member 2 and the power-generating rotating member 3 (i.e., stator) are placed inside the supporting member 11. Afterward, the covering member 12 is placed over the supporting member 11, forming a complete enclosure body 1, facilitating convenient installation. Subsequently, air inside the enclosed space 13 is evacuated using a vacuum device, creating a vacuum state within the enclosed space 13. Since the vacuuming technique applies existing technologies, further details are omitted.

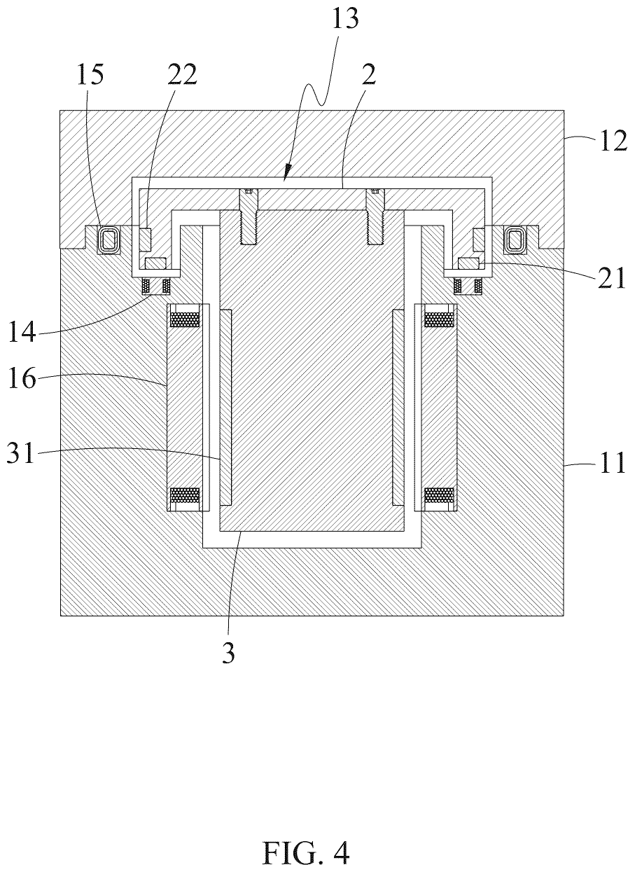

To initiate power generation, electrical current from the power supply device 5 is controlled by the status control element 6. As shown in FIGS. 4 to 7, electrical current is directed into the second magnetic levitation elements 14 and the second rotational magnetic elements 15 to control their magnetic states. At this stage, the second magnetic levitation elements 14 and the first magnetic levitation elements 21 generate a repelling force, forming a magnetic levitation condition that keeps the magnetic levitation rotating member 2 in a suspended state. Meanwhile, the magnetic state produced by the second rotational magnetic elements 15 interacts with the magnetic force of the first rotational magnetic elements 22, creating a structure similar to a linear synchronous motor. This mechanism drives the magnetic levitation rotating member 2 to rotate, similar to that of a linear synchronous motor. Thus, the magnetic levitation rotating member 2 can continuously rotate within the enclosure body 1, operating similarly to a magnetic levitation train. In this embodiment, electromagnetic levitation is used for magnetic levitation operation, though the method is not limited to this and could also be achieved using superconducting magnetic levitation.

When the magnetic levitation rotating member 2 rotates, it drives the power-generating rotating member 3 (i.e., rotor) beneath it to rotate synchronously. As the power-generating rotating member 3 spins, its power-generating magnetic elements 31 induce an electric current in the power-generating coils 16 (i.e., stator) through electromagnetic effects. In this configuration, the power-generating rotating member 3 functions as the rotor as in electric generators, while the power-generating coils 16 on the enclosure body 1 act as the stator. This setup enables electricity generation, with the induced current from the power-generating coils 16 directed into the energy storage device 4 and the power supply device 5 for replenishment. To access power, the energy storage device 4 can be directly connected to use the stored electricity. To stop power generation, power supply to the second magnetic levitation elements 14 and the second rotational magnetic elements 15 can be cut off by controlling the power supply device 5 via the status control element 6. Without rotational and levitation forces, the magnetic levitation rotating member 2 and the power-generating rotating member 3 will gradually stop rotating. Therefore, this invention operates in accordance with the law of energy conservation.

Since the magnetic levitation rotating member 2 and the power-generating rotating member 3 remain in a magnetic levitation state while rotating, they do not come into contact with any components during operation. Additionally, because they rotate within the vacuum-sealed enclosed space 13, air friction is minimized, reducing rotational energy loss to the lowest possible level and enhancing power generation efficiency. The vacuum environment also prevents foreign objects or dust from entering, reducing the likelihood of operational blockage due to debris buildup. This lowers the overall risk of mechanical failure. Moreover, the system operates without requiring additional fuel or emitting exhaust gases, ensuring a noise-free, environmentally friendly operation that poses no harm to human health.

Since the present invention generates electricity through electromagnetic effects, it does not cause environmental pollution, naturally achieving green energy generation. Additionally, this power generation process, which combines magnetic levitation and electromagnetic effects, is unaffected by environmental factors. It can be manufactured in any size and installed in various environments, enhancing usability while eliminating energy losses during power transmission, significantly boosting efficiency in both production and application. Because the present invention uses a control method similar to that of a linear motor, the rotation speed and direction of the magnetic levitation rotating member 2 and the power-generating rotating member 3 can be controlled by adjusting magnetic forces. The current generated by the power-generating coils 16 is directly related to the rotational speed of the power-generating magnetic elements 31 driven by the power-generating rotating member 3. This allows precise control of rotational speed and current output based on demand. Since the system operates using magnetic levitation in a vacuum environment, it achieves frictionless power generation. The output can be adjusted by changing the rotational speed, enabling high power output driven by a low power input. The output value can be thousands or even millions of times greater than the input, creating an amplifier-like effect similar to an electric generator. However, the present invention merely applies the described mechanism to achieve an amplification-like effect without violating the law of energy conservation.

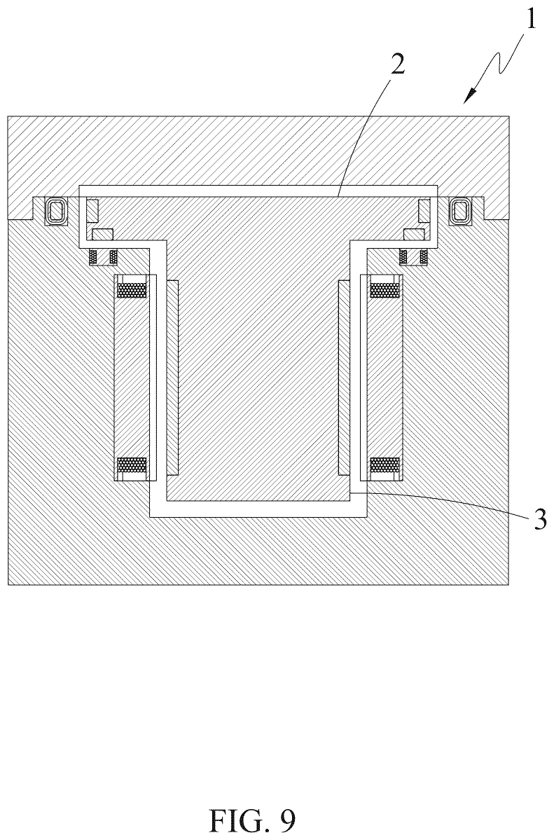

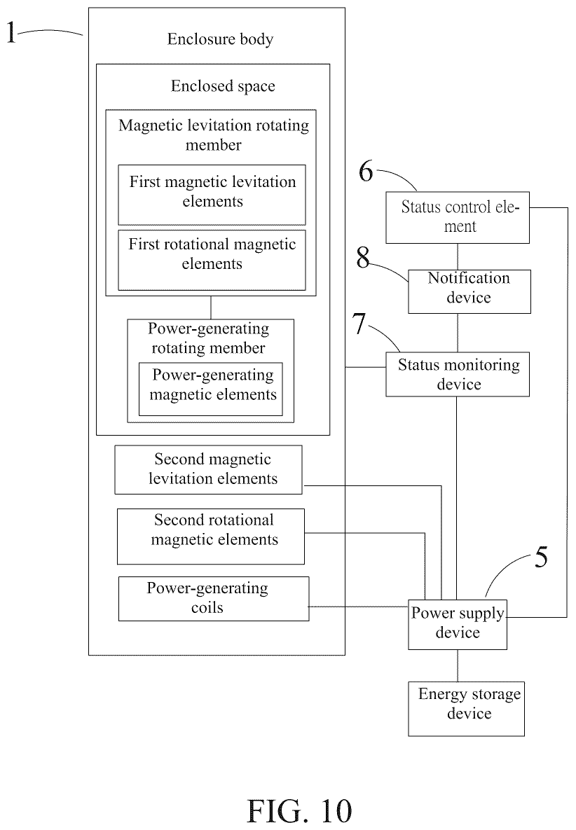

As shown in FIGS. 9 and 10, in a second embodiment of the present invention, the magnetic levitation rotating member 2 and the power-generating rotating member 3 are integrally formed. This design enhances the structural stability between the two components. Additionally, as shown in FIG. 9, the magnetic levitation rotating member 2 is a fully circular disc, indicating that the shapes of the magnetic levitation rotating member 2 and the power-generating rotating member 3 are not limited to specific configurations.

In the present embodiment, the power supply device 5 and the enclosure body 1 are data-linked a status monitoring device 7. The status monitoring device 7 and the status control element 6 are also data-linked to a notification device 8. The notification device 8 is exemplified by a notification software that can connect to relevant personnel. Through the status monitoring device 7, the current supplied by the power supply device 5 and the operational status inside the enclosure body 1 can be monitored. In this embodiment, the status monitoring device 7 is exemplified by a combination of a current sensor and a camera. The current sensor detects the current status of the power supply device 5, while the camera observes the operational status inside the enclosure body 1.

When an abnormal condition is detected (e.g., the power supply device 5 stops supplying current or the enclosure body 1 ceases operation), the notification device 8 will alert relevant personnel for inspection and maintenance. Alternatively, a user can proactively observe the motor generator, and if any irregularities are found, the user can directly control the notification device 8 through the status control element 6 to issue an alert. This setup enhances operational safety and improves maintenance efficiency.

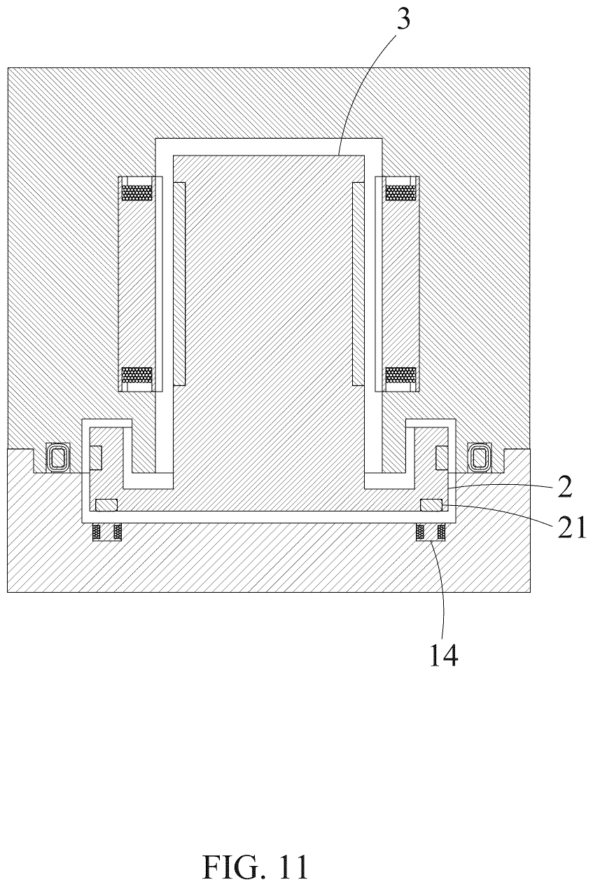

As shown in FIG. 11, in a third embodiment, the magnetic levitation rotating member 2 is joined to a bottom side of the power-generating rotating member 3. The first magnetic levitation elements 21 are arranged on a bottom side of the magnetic levitation rotating member 2, and the second magnetic levitation elements 14 are positioned beneath the magnetic levitation rotating member 2 to generate a magnetic levitation effect by pushing upward. This indicates that the positional relationship between the magnetic levitation rotating member 2 and the power-generating rotating member 3 is not limited to a specific configuration.

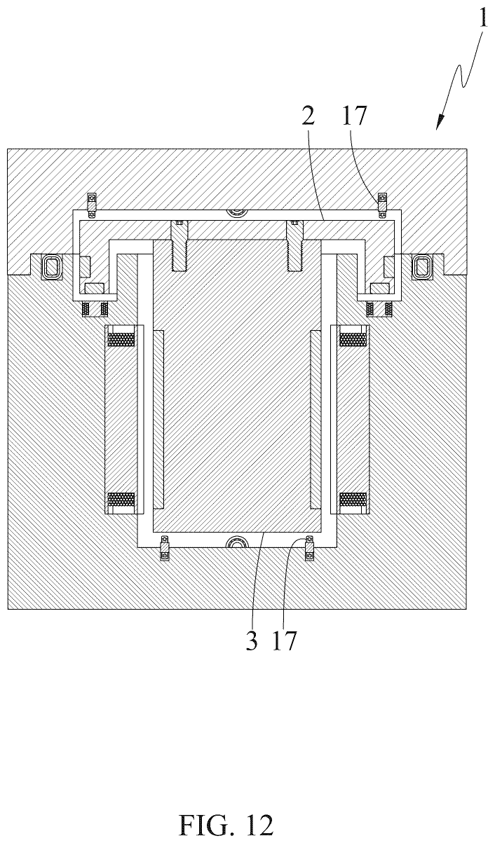

As shown in FIG. 12, in a fourth embodiment, multiple rotational buffer elements 17 are arranged on an inner wall of the enclosure body 1, positioned above and below the magnetic levitation rotating member 2 and the power-generating rotating member 3. In this embodiment, the rotational buffer elements 17 are exemplified by bearing-supported rotatable rollers. If an event such as an earthquake or vibrations from being transported in a vehicle occurs, the rotational buffer elements 17 can prevent the magnetic levitation rotating member 2 and the power-generating rotating member 3 from colliding with the enclosure body 1. Furthermore, since the rotational buffer elements 17 have a rotatable design, even if a collision occurs, they enable smooth rotation without generating additional friction, preventing impact with the enclosure body 1. This design enhances operational safety and extends the lifespan of the motor generator.

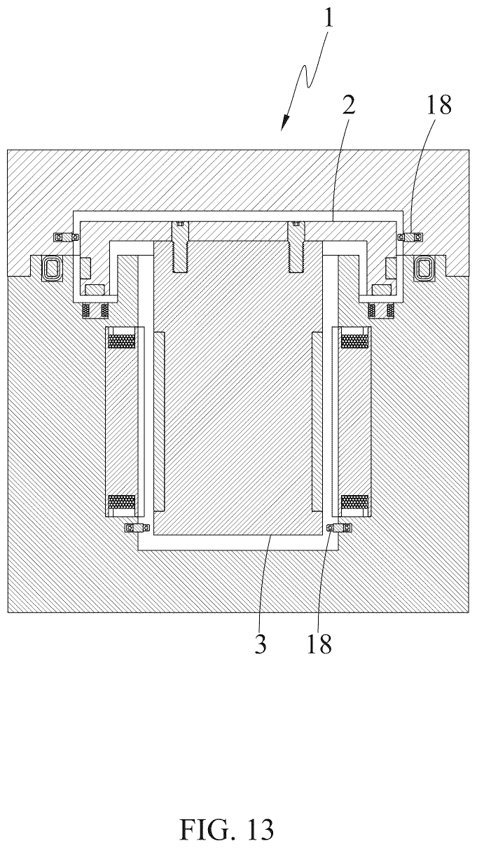

As shown in FIG. 13, in a fifth embodiment, multiple magnetic levitation buffer elements 18 are arranged on the inner wall of the enclosure body 1, positioned around the magnetic levitation rotating member 2 and the power-generating rotating member 3. In this embodiment, the magnetic levitation buffer elements 18 are exemplified by bearing-supported rotatable roller. In the event of disturbances such as an earthquake or vibrations caused by being transported in a vehicle, the magnetic levitation buffer elements 18 can prevent the magnetic levitation rotating member 2 and the power-generating rotating member 3 from colliding with the enclosure body 1. Since the magnetic levitation buffer elements 18 are rotatable, even if a collision occurs, the components enable smooth rotation without generating additional friction. This design prevents impacts with the enclosure body 1, thereby enhancing operational safety and extending the equipment's lifespan.

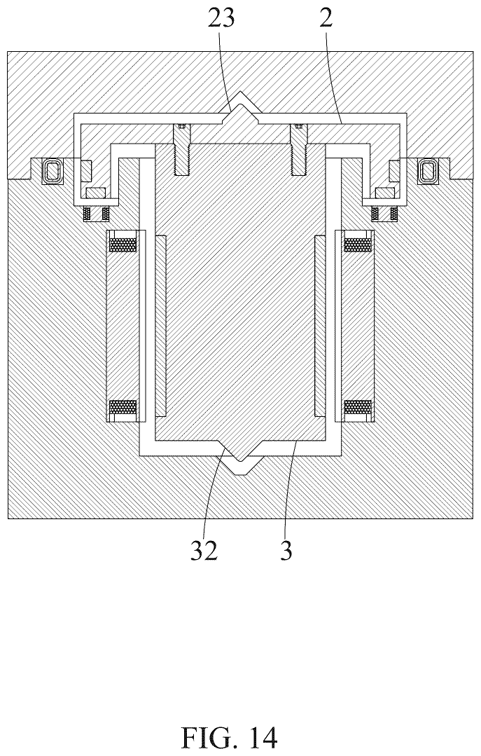

As shown in FIG. 14, in a sixth embodiment, a magnetic levitation center-of-gravity limiting element 23 is arranged on a top side of the magnetic levitation rotating member 2, and a rotor center-of-gravity limiting element 32 is arranged on a bottom side of the power-generating rotating member 3. In this embodiment, both the magnetic levitation center-of-gravity limiting element 23 and the rotor center-of-gravity limiting element 32 are exemplified by outward-protruding pointed structures.

The magnetic levitation center-of-gravity limiting element 23 and the rotor center-of-gravity limiting element 32 are both positioned at a rotational central axis of the magnetic levitation rotating member 2 and the power-generating rotating member 3. They help stabilize the center of gravity during rotation. Additionally, in the event of an impact, these components can provide a limiting effect, reducing the likelihood of damage.

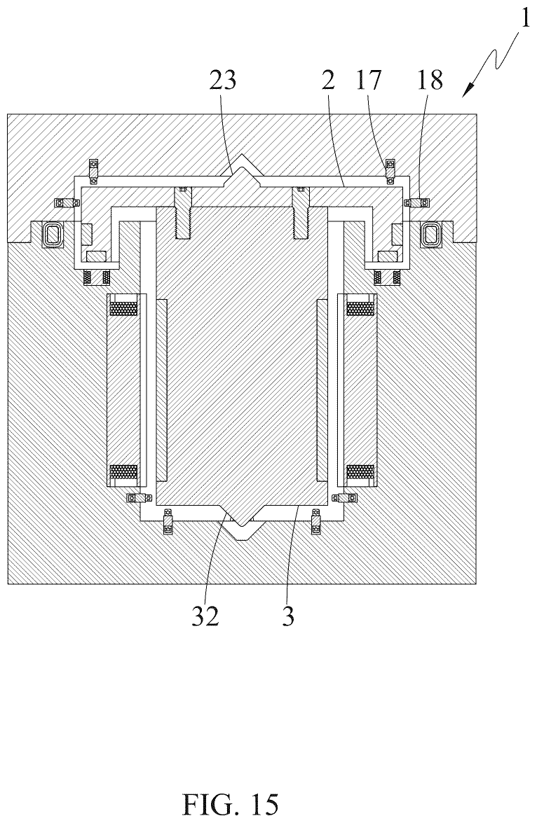

As shown in FIG. 15, in a seventh embodiment, the enclosure body 1 is equipped with multiple rotational buffer elements 17 and multiple magnetic levitation buffer elements 18. Additionally, the magnetic levitation rotating member 2 is fitted with a magnetic levitation center-of-gravity limiting element 23, while the power-generating rotating member 3 is fitted with a rotor center-of-gravity limiting element 32. This configuration demonstrates that the rotational buffer elements 17, magnetic levitation buffer elements 18, magnetic levitation center-of-gravity limiting element 23, and rotor center-of-gravity limiting element 32 can coexist, thereby providing multiple layers of protection.

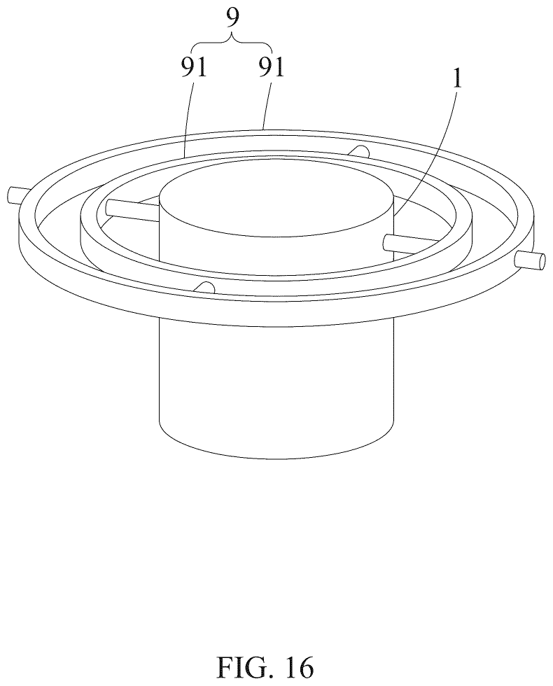

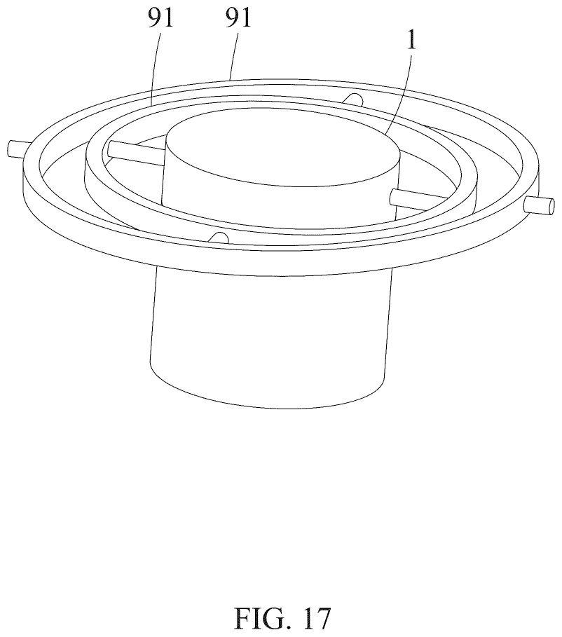

As shown in FIGS. 16 and 17, in an eighth embodiment, a level measuring element 9 is installed on the exterior of the enclosure body 1. In this embodiment, the level measuring element 9 is exemplified by multiple circular rings 91 pivotally attached to the exterior of the enclosure body 1. Due to the inherent weight of the circular rings 91, they act like a seesaw, maintaining a level orientation.

When the enclosure body 1 is in a level state, as shown in FIG. 16, all circular rings 91 remain parallel to an upper surface of the enclosure body 1. If the enclosure body 1 becomes tilted, as shown in FIG. 17, the circular rings 91, due to their weight, will stay in a level position. This causes the circular rings 91 to no longer align parallel to the upper surface of the enclosure body 1, allowing the user to easily determine the level status of the enclosure body 1. When adjustments are needed (e.g., after moving the enclosure body 1), the user can promptly use the level measuring element 9 as a reference for realignment.

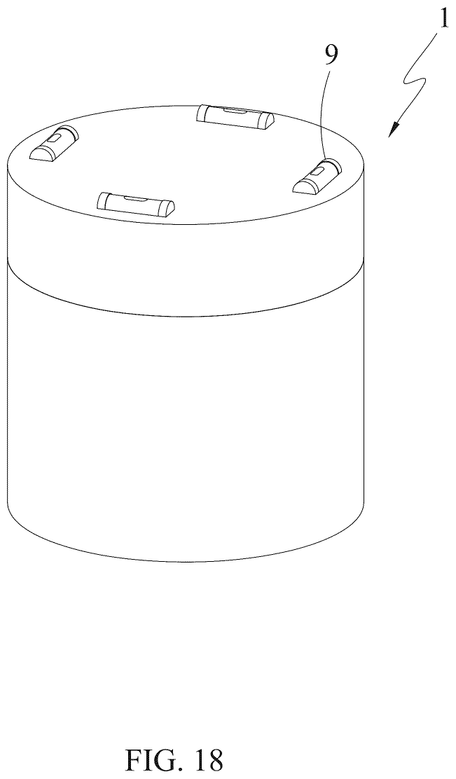

As shown in FIG. 18, in a ninth embodiment, the level measuring element 9 is exemplified as a spirit level installed on the upper surface of the enclosure body 1, indicating that the type of level measuring element 9 is not limited to specific designs.

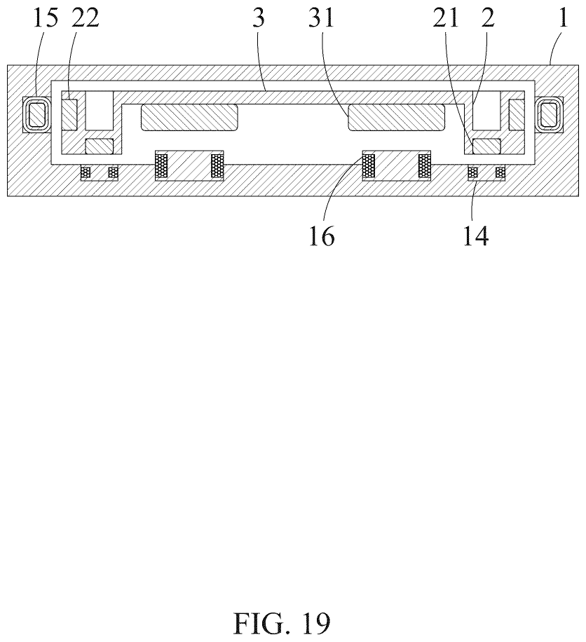

As shown in FIG. 19, in a tenth embodiment, the enclosure body 1 is presented in a miniaturized form, where the magnetic levitation rotating member 2 and the power-generating rotating member 3 are integrated into a single disc-like structure. The power-generating rotating member 3 is defined as the central area of the magnetic levitation rotating member 2. The power-generating magnetic elements 31 are similarly arranged on the power-generating rotating member 3. The magnetic levitation rotating member 2 is maintained in a levitated state through the interaction of the first magnetic levitation elements 21 and the second magnetic levitation elements 14. Additionally, the magnetic levitation rotating member 2 and the power-generating rotating member 3 are driven by the interaction between the first rotational magnetic elements 22 and the second rotational magnetic elements 15. This enables the power-generating magnetic elements 31 to work in conjunction with the power-generating coils 16 to generate electricity.

Through the above-described structures, it is demonstrated that the configuration of the present invention is not limited to specific forms. It can achieve a miniaturized design, making it adaptable for installation in various locations and machinery, such as residential buildings or different types of vehicles, thereby enhancing the practicality of the present invention.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A motor generator, comprising:
an enclosure body;
an enclosed space formed within the enclosure body, where the enclosed space is in a vacuum state;
a magnetic levitation rotating member rotatably configured within the enclosed space;
a plurality of first magnetic levitation elements configured on the magnetic levitation rotating member;
a plurality of second magnetic levitation elements configured on the enclosure body positioned correspondingly to the first magnetic levitation elements, where the magnetic levitation rotating member is in a magnetic levitation state by the first and second magnetic levitation elements;
a plurality of first rotational magnetic elements configure on the magnetic levitation rotating member;
a plurality of second rotational magnetic elements configured on the enclosure body positioned correspondingly to the first rotational magnetic elements, where the magnetic levitation rotating member is driven to rotate by magnetic force between the first and second rotational magnetic elements;
a power-generating rotating member configured within the enclosed space and fixed to the magnetic levitation rotating member;
a plurality of power-generating magnetic elements configured on the power-generating rotating member;
a plurality of power-generating coils configured on the enclosure body adjacent to the power-generating magnetic elements, where current is induced in the power-generating coils by the power-generating magnetic elements;
an energy storage device electrically connected to the power-generating coils;
a power supply device electrically connected to the power-generating coils, the second magnetic levitation elements, and the second rotational magnetic elements, where current is received from the power-generating coils and supplied to the second magnetic levitation elements the second rotational magnetic elements; and
a status control element data-linked to the power supply device controlling current supplied to the second magnetic levitation elements and the second rotational magnetic elements.

2. The motor generator according to claim 1, further comprising a status monitoring device data-linked to the power supply device and the enclosure body.

3. The motor generator according to claim 2, further comprising a notification device data-linked to the status monitoring device and the status control element.

4. The motor generator according to claim 1, wherein the magnetic levitation rotating member and the power-generating rotating member spin in the enclosed space which is in a vacuum state.

5. The motor generator according to claim 1, wherein a plurality of rotational buffer elements are arranged along an inner wall of the enclosure body.

6. The motor generator according to claim 1, wherein a plurality of magnetic levitation buffer elements are arranged along an inner wall of the enclosure body.

7. The motor generator according to claim 1, wherein the magnetic levitation rotating member is equipped with a magnetic levitation center-of-gravity limiting element; and the power-generating rotating member is equipped with a rotor center-of-gravity limiting element.

8. The motor generator according to claim 1, wherein the first magnetic levitation elements and the second magnetic levitation elements achieve magnetic levitation to the magnetic levitation rotating member through electromagnetic levitation or superconducting magnetic levitation.

9. The motor generator according to claim 1, wherein the first magnetic levitation elements and the first rotational magnetic elements are permanent magnets.

10. The motor generator according to claim 1, wherein the second magnetic levitation elements and the second rotational magnetic elements are excitation coils.
